(19) United States
(12) Patent Application Publication
(10) Pub. No.: US 2026/0189056 A1
(43) Pub. Date: Jul. 2, 2026

(54) EMERGENCY POWER SUPPLY CAPABLE OF TURNING OFF SENSOR IN EMERGENCY LIGHTING MODE

(71) Applicant: SHENZHEN BILLDA TECHNOLOGY CO.,LTD, SHENZHEN (CN)

(72) Inventors: JIANJUN KE, SHENZHEN (CN); QIU FENG, SHENZHEN (CN)

(21) Appl. No.: 19/007,827

(22) Filed: Jan. 2, 2025

(51) Int. Cl. H02J 9/06; H02J 7/02; H05B 45/38

(52) U.S. Cl. CPC H02J 9/065; H02J 7/02; H05B 45/38

(57) ABSTRACT

An emergency power supply capable of turning off a sensor in an emergency lighting mode is used for transmitting a current to an LED driver when mains power is cut off. The LED driver is connected to the mains power. After receiving a current input by the mains power, the LED driver converts the current into a direct current and outputs the direct current to an LED light. When the mains power is normal, the emergency power supply supplies power to the sensor. When the mains power is cut off, the emergency power supply stops supplying power to the sensor. Compared with the prior art, the emergency power supply cannot supply power to the sensor in an emergency lighting mode, and the sensor will be turned off, thus guaranteeing the safety of users in an emergency.

### BACKGROUND OF THE INVENTION

### 1. Technical Field

The disclosure relates to the technical field of emergency lighting, in particular to an emergency power supply capable of turning off a sensor in an emergency lighting mode.

### 2. Description of Related Art

LED lights on the market are typically provided with a sensor for controlling on/off of lighting, such as a sound sensor or a body sensor. In the prior art, a conventional power supply is often used to drive the sensor to operate, and under the condition that mains power is cut off, an emergency power supply supplies power to the conventional power supply, and the conventional power supply supplies power to the sensor normally. In this way, the sensor can still control on/off of lighting in a case of emergency lighting, which will lead to potential safety hazards. Therefore, an emergency power supply that can turn off the sensor in an emergency lighting mode is needed to solve this problem.

### BRIEF SUMMARY OF THE INVENTION

In view of the defects in the prior art, the objective of the disclosure is to provide an emergency power supply capable of turning off a sensor in an emergency lighting mode.

To fulfill the above objective, an emergency power supply capable of turning off a sensor in an emergency lighting mode is used for transmitting a current to an LED driver when mains power is cut off, wherein the LED driver is connected to the mains power; after receiving a current input by the mains power, the LED driver converts the current into a direct current and outputs the direct current to an LED light; when the mains power is cut off, the LED driver receives the current input by the emergency power supply to drive the LED light to work; a sensor is connected to the LED driver; when the mains power is normal, the emergency power supply supplies power to the sensor; and when the mains power is cut off, the emergency power supply stops supplying power to the sensor.

Preferably, the emergency power supply sequentially comprises a rectification and filter unit and a battery unit, wherein the mains power is connected to the battery unit by means of the rectification and filter unit; when the mains power is normal, an input current passes through the rectification and filter unit to charge the battery unit; and when the mains power is cut off, the battery unit supplies power to the LED driver.

Preferably, the emergency power supply further comprises a main control unit, wherein the main control unit is connected to the rectification and filter unit, the battery unit, the boost unit and the sensor; when the mains power is normal, the main control unit controls the rectification and filter unit to operate to transmit a current to the sensor; and when the mains power is cut off, the main control unit controls the battery unit to supply power to the LED driver.

Preferably, the emergency power supply further comprises a boost unit, wherein the battery unit supplies power to the LED driver by means of the boost unit.

Preferably, the emergency power supply further comprises an auxiliary power supply, wherein the auxiliary power supply is connected between the main control unit and the sensor and connected to an expansion interface, which is connected to an external device.

Preferably, the auxiliary power supply comprises a voltage conversion module, and the voltage conversion module is connected to an output terminal of a boost unit and used for converting a voltage input by the boost unit into a 12V voltage.

The disclosure has the following beneficial effects: the emergency power supply capable of turning off a sensor in an emergency lighting mode is used for transmitting a current to the LED driver when the mains power is cut off, the LED driver is connected to the mains power; after receiving a current input by the mains power, the LED driver converts the current into a direct current and outputs the direct current to the LED light; when the mains power is cut off, the emergency power supply transmits a current to the LED driver, and the LED driver receives the current input the emergency power supply to drive the LED light to work; the sensor is connected to the LED driver; when the mains power is normal, the emergency power supply supplies power to the sensor; and when the mains power is cut off, the emergency power supply stops supplying power to the sensor, that is, when the mains power is cut off, the sensor will be turned off automatically, such that the sensor cannot control lighting in an emergency lighting mode, thus improving the safety of users.

### BRIEF DESCRIPTION OF THE SEVERAL VIEWS OF THE DRAWINGS

FIG. 1 is a block diagram according to the disclosure.

FIG. 2 is a circuit diagram of an auxiliary power supply according to the disclosure.

FIG. 3 is a circuit diagram of a voltage conversion module according to the disclosure.

### MAIN REFERENCE SIGNS

1, emergency power supply; 11, rectification and filter unit; 12, battery unit; 13, boost unit; 14, main control chip; 15, auxiliary power supply; 16, expansion interface; 2, LED driver; 3. LED light; 4, sensor.

### DETAILED DESCRIPTION OF THE INVENTION

To better clarify the disclosure, the disclosure is further described below in conjunction with accompanying drawings.

As described above, an existing emergency power supply will still supply power to a sensor when mains power is cut off and the sensor can still control on/off of lighting in a case of emergency lighting, leading to potential safety hazards.

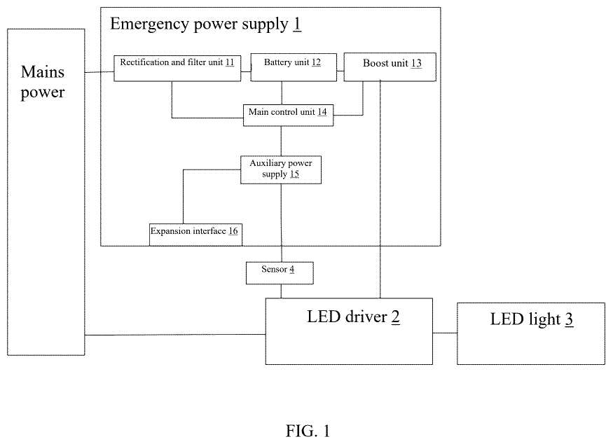

In view of this, referring to FIG. 1, the disclosure provides an emergency power supply capable of turning off a sensor in an emergency lighting mode. The emergency power supply 1 is used for transmitting a current to an LED driver 2 when mains power is cut off; the LED driver 2 is connected to the mains power, and after receiving a current input by the mains power, the LED driver 2 converts the current into a direct current and outputs the direct current to an LED light 3; when the mains power is cut off, the LED driver 2 receives the current input by the emergency power supply 1 to drive the LED light 3 to work. A sensor 4 is connected to the LED driver 2; when the mains power is normal, the emergency power supply 1 supplies power to the sensor 4; and when the mains power is cut off, the emergency power supply 1 stops supplying power to the sensor 4. In this way, when the mains power is cut off, the emergency power supply cannot supply power to the sensor, that is, when the mains power is cut off, the sensor will be turned off automatically.

In this embodiment, users can install different sensors as actually needed, and the sensor may be a body sensor, an infrared sensor, a sound sensor, or the like. For example, in a case where the emergency power supply with the emergency function and the lighting function is used in a corridor, a body sensing device or a sound control device may be installed.

In this embodiment, the emergency power supply 1 sequentially comprises a rectification and filter unit 11 and a battery unit 12, and the mains power is connected to the battery unit 12 by means of the rectification and filter unit 11; when the mains power is normal, an input current passes through the rectification and filter unit 11 to charge the battery unit 12; and when the mains power is cut off, the battery unit 12 supplies power to the LED driver 2.

Preferably, the emergency power supply 1 further comprises a boost unit 13, the battery unit 12 outputs a voltage required by the LED driver 2 by means of the boost unit 13 to guarantee normal operation of the LED driver 2.

In this embodiment, the emergency power supply 1 further comprises a main control unit 14, wherein the main control unit 14 is connected to the rectification and filter unit 11, the battery unit 12, the boost unit 13 and the sensor 4; when the mains power is normal, the main control unit 14 controls the rectification and filter unit 11 to work to transmit a current to the sensor 4; and when the mains power is cut off, the main control unit 14 controls the battery unit 12 to supply power to the LED driver 2. In this way, when the mains power is cut off, the emergency power supply cannot supply power to the sensor anymore, that is, when the mains power is cut off, the sensor will be tuned off automatically.

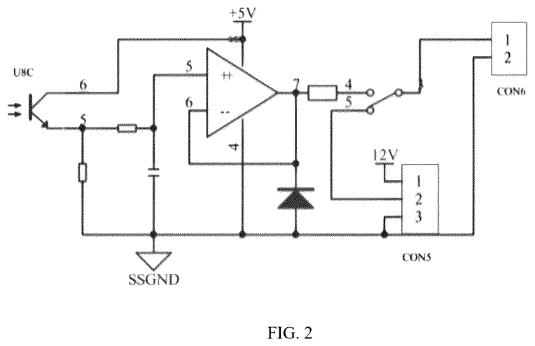

In this embodiment, referring to FIGS. 1 and 2, the emergency power supply 1 further comprises an auxiliary power supply 15, wherein the auxiliary power supply 15 is connected between the main control unit 14 and the sensor 4 and connected to an expansion interface 16, the expansion interface 16 is connected to an external device, and an input interface CON5 of the auxiliary power supply 15 is connected to an output terminal of the rectification and filter unit 11 and an output terminal of the boost unit 13 by means of the main control unit 14; when the mains power is normal, the input interface CON5 receives power input by the rectification and filter unit 11; and when the mains power is cut off, the input interface CON5 receives power input by the boost unit. In this way, no matter whether the mains power is normal, the input interface CON5 can guarantee normal operation of the device connected to the expansion interface. For example, in a case where the device connected to the expansion interface is a dimming device, when the mains power is cut off, the dimming device can still work to control the LED light 3 to operate at a low power to prolong the operation time in an emergency.

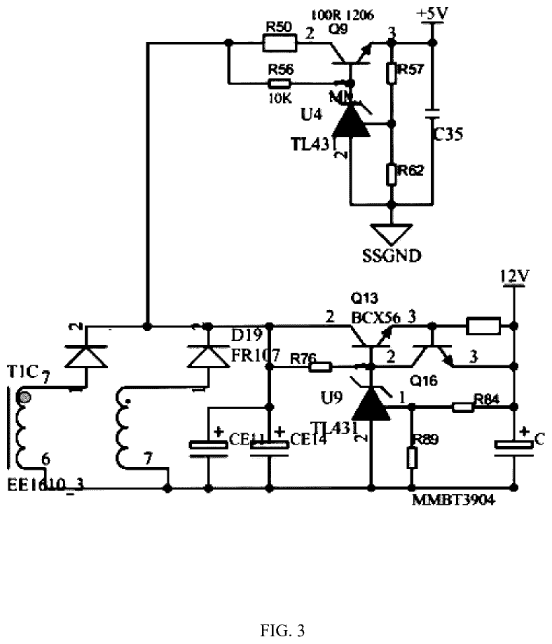

Referring to FIG. 3, preferably, the auxiliary power supply comprises a voltage conversion module connected to the output terminal of the boost unit. The voltage conversion module is used for converting a voltage input by the boost unit 13 into a 12V voltage to supply power to the input interface, and the input interface supplies power to the sensor to prevent the external device from being burnt out by an excess voltage.

In another embodiment, the auxiliary power supply not only can supply power to the sensor, but also can supply power to the emergency power supply, such that the emergency power supply can output a voltage and current to a common power supply of users to turn on a light for emergency lighting.

Further, in another embodiment, the auxiliary power supply can receive, by means of the expansion interface, a 12V voltage input by an external power supply device, and the voltage conversion module can convert the 12V voltage into other voltages, which are then output to other external devices or the boost unit, such that the emergency power supply can work normally in case of a fault of the battery unit, power can be supplied to multiple external devices with different operating voltages, and voltage outputs are diversified.

The disclosure has the following advantages:
1. The LED driver receives mains power to supply power to the sensor; when the mains power is cut off, the sensor will be turned off, such that the technical problem that the sensor still operates in an emergency lighting mode is solved;
2. The input interface of the auxiliary power supply is connected to the output terminal of the rectification and filter unit and the output terminal of the boost unit, such that no matter whether the mains power is normal, the input interface can guarantee normal operation of an external control module.

Several specific embodiments of the disclosure are disclosed above, but the disclosure is not limited to the above embodiments. Any transformations that can be obtained by those skilled in the art should also fall within the protection scope of the disclosure.

What is claimed is:

1. An emergency power supply capable of turning off a sensor in an emergency lighting mode, being used for transmitting a current to an LED driver when mains power is cut off, wherein the LED driver is connected to the mains power; after receiving a current input by the mains power, the LED driver converts the current into a direct current and outputs the direct current to an LED light; when the mains power is cut off, the LED driver receives the current input by the emergency power supply to drive the LED light to work; a sensor is connected to the LED driver; when the mains power is normal, the emergency power supply supplies power to the sensor; and when the mains power is cut off, the emergency power supply stops supplying power to the sensor.

2. The emergency power supply capable of turning off a sensor in an emergency lighting mode according to claim 1, sequentially comprising a rectification and filter unit and a battery unit, wherein the mains power is connected to the battery unit by means of the rectification and filter unit; when the mains power is normal, an input current passes through the rectification and filter unit to charge the battery unit; and when the mains power is cut off, the battery unit supplies power to the LED driver.

3. The emergency power supply capable of turning off a sensor in an emergency lighting mode according to claim 2, further comprising a main control unit, wherein the main control unit is connected to the rectification and filter unit, the battery unit, the boost unit and the sensor; when the mains power is normal, the main control unit controls the rectification and filter unit to operate to transmit a current to the sensor; and when the mains power is cut off, the main control unit controls the battery unit to supply power to the LED driver.

4. The emergency power supply capable of turning off a sensor in an emergency lighting mode according to claim 3, further comprising a boost unit, wherein the battery unit supplies power to the LED driver by means of the boost unit.

5. The emergency power supply capable of turning off a sensor in an emergency lighting mode according to claim 3, further comprising an auxiliary power supply, wherein the auxiliary power supply is connected between the main control unit and the sensor and connected to an expansion interface, which is connected to an external device.

6. The emergency power supply capable of turning off a sensor in an emergency lighting mode according to claim 5, wherein the auxiliary power supply comprises a voltage conversion module, and the voltage conversion module is connected to an output terminal of a boost unit and used for converting a voltage input by the boost unit into a 12V voltage to supply power to the sensor.
